(19) United States
(12) Patent Application Publication
(10) Pub. No.: US 2026/0093559 A1
(43) Pub. Date: Apr. 2, 2026

(54) Unified Application Programming Interface

(71) Applicant: PayPal, Inc., San Jose, CA (US)

(72) Inventors: Samuel John Parsons, Des Moines, IA (US); Benjamin Breaux Coumes, New Orleans, LA (US)

(21) Appl. No.: 18/900,163

(22) Filed: Sep. 27, 2024

(51) Int. Cl. G06F 9/54

(52) U.S. Cl. CPC G06F 9/541

(57) ABSTRACT

Techniques are disclosed relating to implementing a unified application programming interface (API) to facilitate operations across multiple service provider systems. A computer system implements a portion of the unified API that enables it to issue requests in a common format to a variety of service provider systems capable of performing operations of a particular type. The computer system receives a request to facilitate an operation of the particular type through a target service provider system and identifies an appropriate connector associated with the target service provider system based on the request. The computer system then sends a request conforming to the unified API to the identified connector to facilitate the operation at the target service provider system. The identified connector conforms content of the request into a format ingestible by the target service provider system and then forwards that request to the target service provider system for processing.

### BACKGROUND

### Technical Field This disclosure relates generally to computer systems and, more specifically, to various mechanisms for implementing a unified application programming interface (API).

### Description of the Related Art

Services provided through software applications often form a hierarchical structure in which a higher-level service utilizes the functionality provided by a lower-level service of that hierarchical structure. In many cases, the higher-level service enables a yet higher-level service to utilize or otherwise benefit from the functionality of the lower-level service while hiding the complexity that is involved in interacting with the lower-level service. For example, the lower-level service may provide a complex API while potentially requiring compliance with certain requirements or regulations (e.g., a certain level of computer security for data, such as protected storage of the data and secure transfer of the data). By hiding this complexity, the higher-level service can simplify at least a portion of the development of the yet higher-level service as the developer does not have to focus on managing interactions with the lower-level service.

One example of a service provider hierarchy involves Infrastructure as a Service (IaaS) providers, Platform as a Service (PaaS) providers, and Software as a Service (SaaS) providers. At the base of this service provider hierarchy are the IaaS providers, an IaaS provider typically provides computer resources (e.g., computing, storage, networking, etc.) in a virtualized form via the Internet. At the next higher level are the PaaS providers, a PaaS provider implements a platform that allows users to deploy, run, and manage custom cloud applications without the complexity of building and maintaining servers and infrastructure. The PaaS provider interacts with the IaaS provider to manage the provisioning of the computer resources provided by the IaaS provider. At the next higher level are the SaaS providers, a SaaS provider provides cloud-based applications to users. The SaaS provider interacts with the PaaS provider to deploy their applications using the platform provided by the PaaS provider.

### BRIEF DESCRIPTION OF THE DRAWINGS

FIG. 1 is a block diagram illustrating example elements of a system having an execution service that interfaces with multiple service provider systems through a unified API, according to some embodiments.

FIG. 2 is a block diagram illustrating example interactions between an execution service system and multiple service provider systems via connectors, according to some embodiments.

FIG. 3A is a block diagram illustrating an example configuration store storing connector data, according to some embodiments.

FIG. 3B is a block diagram illustrating an example of a service provider system registering multiple connector configuration records, according to some embodiments.

FIG. 4 is a block diagram illustrating an example of a user device triggering, via a service provider system, a system of record, an execution service system, and a connector, a service provider system to perform an operation of a particular type, according to some embodiments.

FIG. 5 is a block diagram illustrating example elements of an asynchronous notification process, according to some embodiments.

FIG. 6 is a block diagram illustrating example elements of an authorization process that pertains to interactions between a system of record, an execution service system, and a connector, according to some embodiments.

FIG. 7-9 are flow diagrams illustrating example methods that pertain to facilitating an operation at a service provider system through a unified API, according to some embodiments.

FIG. 10 is a block diagram illustrating elements of a computer system for implementing various systems described in the present disclosure, according to some embodiments.

### DETAILED DESCRIPTION

In modern service architectures, service providers face challenges in integrating with multiple third-party service provider systems to deliver comprehensive services to end-users. In many cases, integrating with those service provider systems involve complex APIs and stringent compliance requirements. This complexity can arise because each service provider system operates independently, with its own unique API protocols, data formats, and security standards. Accordingly, a service provider wishing to integrate their system with other service provider systems may develop and maintain multiple integrations, each tailored to the specific requirements of a service provider system, and thus the service provider may incur substantial development overhead and operational complexity. Moreover, any updates or changes to the service provider systems may necessitate corresponding updates to the integrations, further increasing the maintenance burden. Thus, this fragmented approach may not only strain resources but also may introduce risks of inconsistencies and errors in the interactions with the service provider systems. Consequently, service providers that seek to integrate with multiple service provider systems find themselves unable to offer particular functionalities to end-users, thereby limiting their service offerings and reducing their competitive edge. This disclosure addresses, among other things, the technical problem of how to integrate with multiple service provider systems in a manner that overcomes one or more of the above deficiencies.

In various embodiments described below, a computer system implements a unified API that standardizes the interactions between that computer system and multiple service provider systems. The unified API enables the computer system to issue requests in a consistent format to those service provider systems, regardless of their individual protocols and data formats. In various embodiments, the computer system resides between another service provider system and the multiple service provider systems and enables that other service provider system to interact with the multiple service provider systems. The service providers of those systems may implement connectors according to a set of specifications of the unified API and register them with the computer system. A connector may act as an intermediary that interfaces with one of the multiple service provider systems by translating standardized requests from the unified API to a format that is ingestible by that service provider system and vice-versa for the responses. When the other service provider system seeks to perform an operation of a particular type at a target service provider system, it may issue a request to the computer system. In various embodiments, the computer system identifies a connector associated with the target service provider system and sends a request conforming to the unified API to the identified connector to trigger the operation at the target service provider system. The connector may communicate with the target service provider system to perform the requested operation and return any response in a standardized format. Accordingly, the disclosed techniques may facilitate integration with multiple service provider systems, enabling a service provider to offer a broader range of functionalities without significant modifications to their existing system.

The unified API may take different forms in different embodiments. For example, the unified API may be a REpresentational State Transfer (REST) API, a WebSocket-based API, a Remote Procedure Call-based (RPC) API, a Webhook-based API, a GraphQL-based API, or a simple object access protocol-based (SOAP) API. The unified API may thus be implemented using any of various architectural styles employed in API design. Furthermore, while separate service provider systems are discussed, in some embodiments, one or more service providers may implement a software product as a collection of microservices. The unified API may be used to allow a microservice to interact with multiple other microservices, regardless of their individual protocols and data formats.

In some embodiments, the disclosed system includes a system of record (or is coupled to a system of record) utilized by a service provider. The unified API may allow the service provider to perform operations at multiple service provider systems and store the results of those operations in the system of record. In particular, responses from the service provider systems may conform to a common/standardized format that allows for the system of record to serve as a centralized repository for the service provider. As a result, this approach may enable the service provider to offer additional functionalities to users (since it can interact with different service provider systems having different functionalities) while maintaining its existing integration with the system of record. A service provider's system of record may thus retain its role as the authoritative source for operational data, ensuring consistency and reliability.

In some embodiments, the disclosed system supports asynchronous communication for real-time updates, ensuring accurate maintenance of operation statuses across different service providers. For example, when an operation status is updated by a service provider system, an asynchronous notification may be sent to the disclosed system, and the system may route that notification to the appropriate connector. The connector may process the notification and then return a response to the system, which may update an operation record in the system of record that describes an operation requested by the service provider system that is associated with that system of record. Asynchronous communication may ensure that even if there are delays or latencies in the other service provider systems, the service provider can still provide timely updates to its users.

This unified API approach can be extended to various types of service provider systems enabling higher-level service provider systems to access functionalities from different lower-level service provider systems within a hierarchical service architecture. For example, at the base of a service hierarchy, there may be Infrastructure as a Service (IaaS) providers. An IaaS provider typically provides computer resources (e.g., computing, storage, networking, etc.) in a virtualized form via the Internet. At the next higher level, there can be Platform as a Service (PaaS) providers. A PaaS provider implements a platform that allows users to deploy, run, and manage custom cloud applications without the complexity of building and maintaining servers and infrastructure. The PaaS provider interacts with an IaaS provider to handle the provisioning of the computer resources provided by the IaaS provider. At the next higher level, there can be Software as a Service (SaaS) providers. A SaaS provider provides cloud-based applications to users. The SaaS provider interacts with the PaaS provider to deploy their applications using the platform provided by the PaaS provider. The unified API approach may be used to enable a PaaS provider to interact with multiple IaaS providers so that the PaaS provider can deploy their platform on infrastructures managed by different parties. As a result, a SaaS provider can deploy applications onto different infrastructures since the PaaS provider's platform is deployed on the different infrastructures.

By employing a unified API and standardized connectors, these techniques may provide a flexible and adaptable service architecture. For example, service providers may quickly respond to changing demands and technological advancements by integrating new third-party service systems with minimal effort. Thus, this flexibility may not only improve the overall service quality but also enhance the competitive edge of the service provider in a rapidly evolving digital landscape. Moreover, these techniques may not only simplify the integration process but may also reduce development overhead and potential errors. By abstracting the complexities of multiple integrations into a single unified API, a service provider may streamline their development efforts and focus on delivering enhanced services to their users. Thus, this technical solution involving a unified API and connectors to the technical problem of how to integrate with multiple service provider systems provides an improvement to computer systems and their ability to integrate with one another.

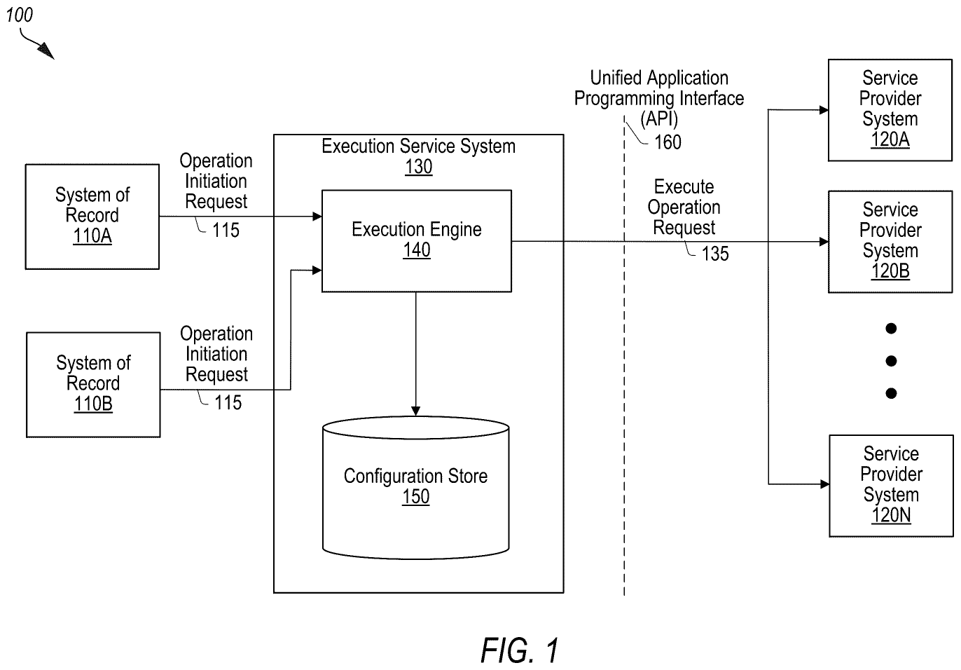

Turning now to FIG. 1, a block diagram of a system 100 is shown. System 100 includes a set of components that may be implemented via hardware or a combination of hardware and software routines. In the illustrated embodiment, system 100 includes systems of record 110A and 110B (also referred to as “systems of record 110”), service provider systems 120A-N (also referred to as “service provider systems 120”), an execution service system 130, and a unified API 160. As further shown, execution service system 130 includes an execution engine 140 and a configuration store 150. System 100 may be implemented differently than shown. For example, system 100 may include a service provider system that interacts with systems of record 110 and/or execution service system 130, execution service system 130 may be part of system of record 110A, and/or configuration store 150 may be separate from execution service system 130.

In various embodiments, one or more components of system 100 are implemented via a cloud infrastructure provided by a cloud provider. As an example, execution service system 130 may use the available cloud resources of a cloud infrastructure (e.g., computing resources, storage resources, etc.) in order to facilitate its operation. As such, software for implementing execution service system 130 (or another component of system 100) may be stored on a non-transitory computer-readable medium of server-based hardware included in a datacenter of the cloud provider and executed within a virtual machine hosted on the server-based hardware. In some cases, a component is implemented without the assistance of a virtual machine or other deployment technologies, such as containerization. In some cases, one or more components of system 100 are implemented via local or private infrastructure as opposed to a public cloud.

Systems of record 110, in various embodiments, are systems that maintain authoritative data records for operations performed by components of system 100 (e.g., by service provider systems 120). Systems of record 110 may include databases or storage systems that may store any of a variety information relating to operations that are performed by service provider systems 120 (as facilitated by execution service system 130), such as transaction records, user profiles, configuration settings, audit logs, performance metrics, communication logs, etc. As shown, systems of record 110 send operation initiation requests 115 to execution service system 130 to request that operations be performed by service provider systems 120. Examples of the types of operations that may be requested include authentication/verification operations (e.g., logins), registration operations (e.g., signups), and payment transaction operations, compute resource allocation operations (e.g., allocating virtual machines), and database transaction operations. By way of example, if a user requests system of record 110A to update their profile information at service provider system 120A, system of record 110A may provide an operation initiation request 115 to execution service system 130 to initiate this update process. Execution service system 130 may then process this request and interact with service provider system 120A to complete the operation. Similarly, if a new transaction may need to be recorded, systems of record 110 can initiate the operation to ensure that this transaction is accurately logged and reflected in the data records.

Service provider systems 120, in various embodiments, are systems that provide one or more services that are accessible to entities (e.g., users and other service provider systems 120) via communication networks. Examples of services that can be provided by a service provider system 120 include an email service, a streaming service, a resource provisioning service (e.g., an IaaS), a platform service (e.g., a PaaS), a web service (e.g., a retail website), and an online payment/transaction processing service. In various embodiments, service provider systems 120 provide at least the same type of service(s) and thus overlap in at least a portion of the functionality that they provide, although service provider systems 120 may also provide other, different services. As an example, in one embodiment, service provider systems 120 are transaction processor systems that provide a service that allows for users/merchants to perform transactions. This embodiment is provided merely as an example and is not intended to limit the scope of this disclosure. In some embodiments, service provider systems 120 provide different types of services and do not provide the same type of service.

While service provider systems 120 can provide the same types of services, in various embodiments, the functionality that they provide through the services can differ. For example, service provider systems 120A and 120B may both provide a PaaS that implements a database that stores data for user applications. But service provider system 120A may provide both relational and non-relational databases to user applications while service provider system 120B provides only relational databases. As an example in the context of transaction processing, service provider systems 120A and 120B may both be transaction processor systems, but only service provider system 120A may provide express checkout functionality that allows users to conduct transactions without having to manually enter their information. In some instances, service provider systems 120 may provide the same features but implement them differently, where one implementation may more efficiently utilize resources than another implementation.

In some embodiments, systems of record 110 may also provide one or more of the same types of services as service provider systems 120 and thus can be considered a type of service provider system. For example, system of record 110A and service provider systems 120 may be transaction processor systems that are located in different jurisdictions. A user might wish to use these different transaction processor systems but have a centralized location where their records are readily available. As such, system of record 110A may serve as the centralized location and facilitate transactions at service provider systems 120 on behalf of that user via execution service system 130. While this non-limiting example relates to service provider systems 120 that are transaction processors that perform transactions, the term “transaction” does not necessarily refer to an interaction between a transaction processor system and a user that is financial in nature. In embodiments in which transaction processor systems provide a financial web service, the “transactions” can be financial transactions. But in embodiments in which the transaction processor systems provide a service that is not financial in nature (e.g., a PaaS that provides a database), the “transaction” can refer to non-financial interactions (e.g., database transactions) between the transaction processor system and a user.

Execution service system 130, in various embodiments, is a system that serves as a bridge between service provider systems 120 and another system, such system of record 110A. Execution service system 130 can thus be responsible for handling operation initiation requests 115 and facilitating communication between systems of record 110A and 110B and service provider systems 120. As shown, execution service system 130 includes execution engine 140. Execution engine 140, in various embodiments, is software executable to process received operation initiation requests 115 and coordinate with corresponding service provider systems 120 via unified API 160 to perform requested operations. Execution engine 140 may ensure that operation initiation requests 115 are executed according to the specifications and protocols defined by unified API 160. Unified API 160, in various embodiments, serves as an abstraction layer that standardizes interactions between execution service system 130 and service provider systems 120. Unified API 160 may be implemented using any of various architectural styles employed in API design. Unified API 160 may define a set of common protocols and data formats that may be adhered to by service provider systems 120 when handling one or more execute operation requests 135. For example, unified API 160 may include specifications that may define how requests and responses are formatted and processed—e.g., security protocols that involve cryptographic signatures, token validation, and/or secure transmission protocols (e.g., Hypertext Transfer Protocol message signature). As such, unified API 160 may simplify the integration process, allowing for a service provider to interact with one or more service provider systems 120 via a single, consistent interface.

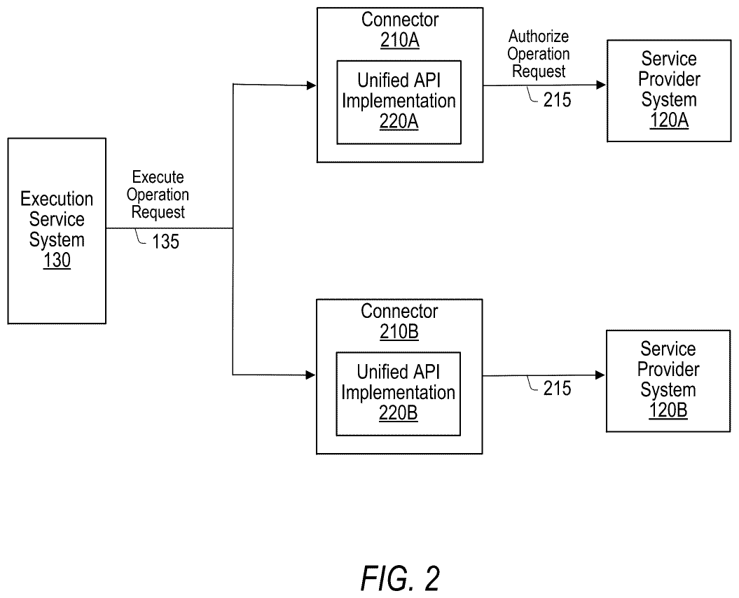

Unified API 160 can be considered a “reverse” API as the provider of execution service system 130 defines the protocols and/or formats that providers of service provider systems 120 have to implement or otherwise support so that execution service system 130 can interact with those service provider systems 120. As discussed in greater detail with respect to FIG. 2, unified API 160 can be implemented, in part, as a set of connectors, where a connector is operable to process requests having a common format from execution service system 130 and conform the content of those requests into a format ingestible by a corresponding service provider system 120. Unified API 160 stands in contrast to a traditional API in which a provider defines how other systems can interact with the provider's system. That is, in various embodiments, unified API 160 defines a scheme that system providers can implement so that clients, such as the execution service system in this embodiment, can interact with all those other systems using the same interface definition. In contrast, a traditional API is defined by the system provider themselves; such system providers APIs may vary widely inhibiting the ability for a client to interact with all of them using the same interface definition.

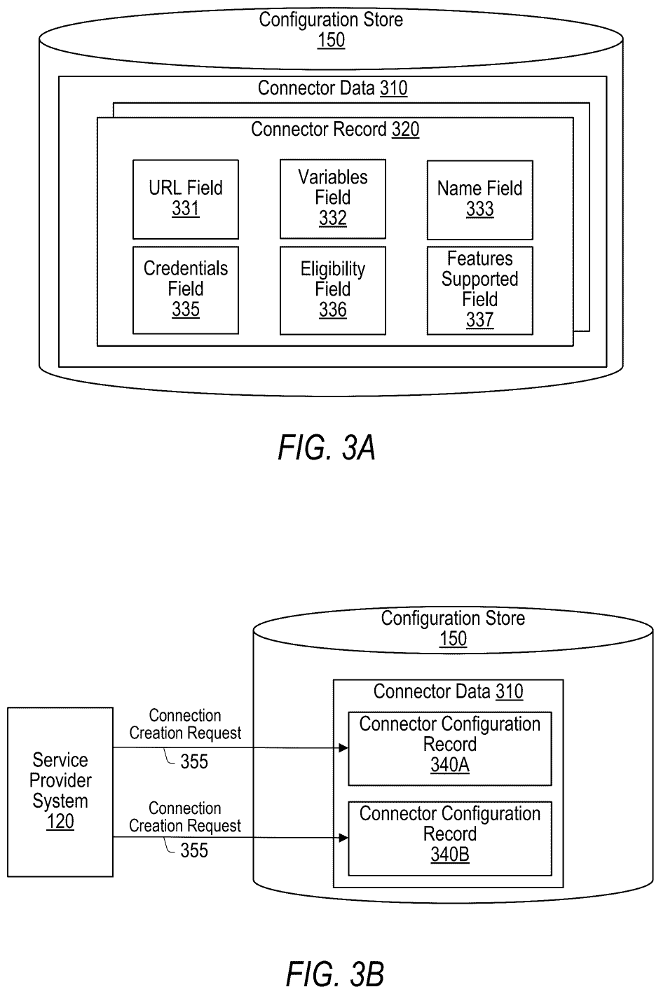

Configuration store 150, in various embodiments, is a data repository used by execution service system 130 to maintain configuration data for interfacing with service provider systems 120. By way of example, this data may include connection details, authentication credentials, and any other configuration settings used by execution engine 140 to communicate effectively with service provider systems 120. Examples of the data stored in configuration store 150 are discussed in greater detail with respect to FIG. 3A. In various embodiments, service providers (or entities) register connectors with execution service system 130 and thus configuration store 150 may store data in association with each registered connector, such as the aforementioned connection details. Configuration store 150 may therefore allow execution service system 130 to dynamically adapt to service provider systems 120 without requiring changes to its functionality. Furthermore, in various embodiments, users may create custom configurations or connections for connectors that allow for execution service system 130 to initiate operations at service provider systems 120 through the connectors on behalf of a user. For example, a user may create a configuration having authentication details that execution service system 130 can provide to a connector (associated with service provider system 120B) to authenticate at service provider system 120B on behalf of the user. These configurations are stored at configuration store 150, in various embodiments. Configurations are discussed in greater detail with respect to FIG. 3B.

Upon receiving an operation initiation request 115 defining a particular operation to be performed by service provider system 120A (for example), in various embodiments, execution engine 140 communicates with configuration store 150 to retrieve the relevant configuration data and then generates execute operation request 135 that conforms to a common format of unified API 160. Execution operation request 135 may identify the particular operation along with other information, such as the authentication details associated with the requesting entity (e.g., a user that initiated it via system of record 110B). Execution service system 130 may send execute operation request 135 to a connector (not shown) associated with service provider system 120A, which may be designed to handle requests conforming to unified API 160. The connector may conform the content of execute operation request 135 to a format ingestible by service provider system 120A. Upon receiving the request, service provider system 120A may process it and generate a corresponding response. Execution engine 140 may receive the response and update system of record 110B with the operation status such that data records may be accurately maintained. This process is discussed in greater detail below.

Turning now to FIG. 2, a block diagram illustrating interactions between execution service system 130 and multiple service provider systems 120 via connectors 210 is shown. In the illustrated embodiment, there are service provider systems 120A and 120B, execution service system 130, and connectors 210A and 210B. As further shown, connectors 210A and 210B include respective unified API implementations 220A and 220B of unified API 160. The illustrated embodiment may be implemented differently than shown. For example, connectors 210A and 210B may not be separate components from their service provider system 120A and 120B—that is, the logic of connector 210A (for example) may be implemented at service provider system 120A.

Connectors 210A and 210B, in various embodiments, are software that is executable to facilitate communication between execution service system 130 and service provider systems 120A and 120B, respectively. Connectors 210A and 210B includes unified API implementations 220A and 220B, respectively, that conforms to the specifications and protocols defined by unified API 160. By way of example, when execution service system 130 provides, to connector 210A, execute operation request 135 that conforms to a common format defined by unified API 160, unified API implementation 220A may process that request and generate authorize operation request 215 that is compatible with service provider system 120A. Similarly, when execution service system 130 issues execute operation request 135 to connector 210B, unified API implementation 220B may process the request and generate authorize operation request 215 to be compatible with service provider system 120B. Execute operation requests 135 provided to connectors 210A and 210B can have the same format (although potentially different contents) while authorize operation requests 215 sent to service provider systems 120A and 120B, respectively, have different formats that conform to the specific design of the respective service provider system. Connectors 210A and 210B may thus each serve as a bridge between execution service system 130 and service provider systems 120A and 120B by converting requests from execution service system 130 that have a format that is understood by execution service system 130 into a format that is understood by service provider systems 120A and 120B. Thus, execution service system 130 may interact with service provider systems 120A and 120B using the same request format independent of the underlying architecture of service provider systems 120A and 120B.

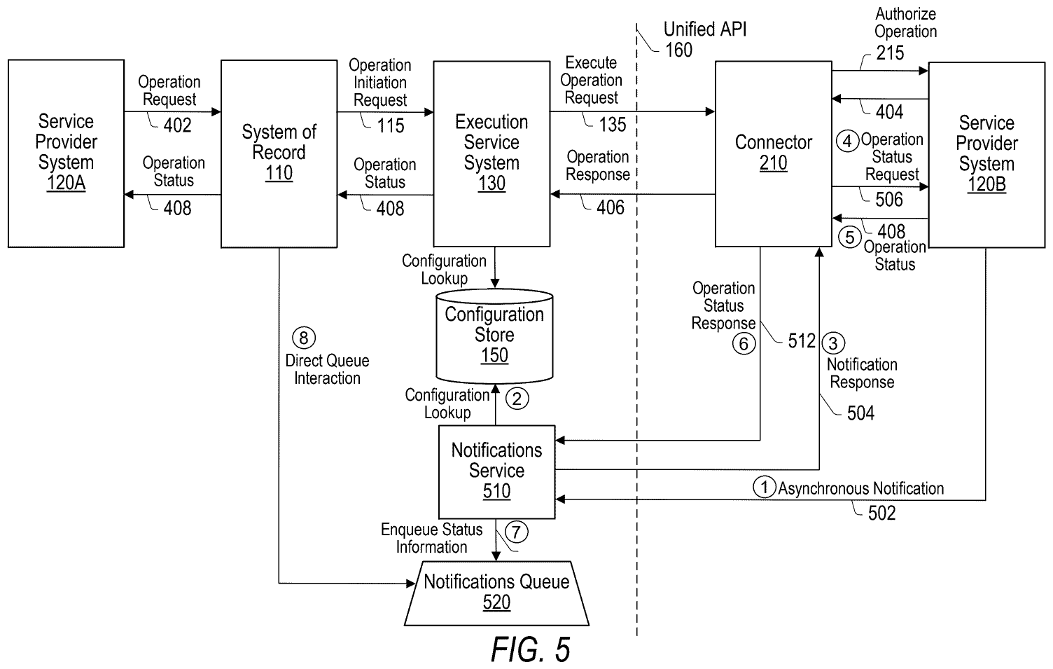

In various embodiments, authorize operation requests 215 that are generated by unified API implementations 220A and 220B include data and parameters specific to service provider systems 120A and 120B, respectively. The data and the parameters may be derived from the contents of execute operation requests 135, which conform to a common format of unified API 160. By converting the contents from the common format into a format that can be received by service provider systems 120A and 120B, this may allow service provider systems 120A and 120B to each process the content according to its own requirements and specifications. After receiving authorize operation requests 215, service provider systems 120A and 120B may perform the requested operation(s). In various embodiments, service provider systems 120A and 120B may generate a response (not shown in FIG. 2) indicating the status of the requested operation(s). As discussed in greater detail with respect to FIG. 5, the response may be processed using a corresponding connector 210, which may then relay the response/outcome to execution service system 130.

The use of connectors 210A and 210B with unified API implementations 220A and 220B may allow execution service system 130 to interact with service provider systems 120A and 120B through a single, standardized interface. This approach may simplify the integration process and reduce the need for execution service system 130 to maintain separate communication protocols for service provider systems 120A and 120B. Furthermore, the modular nature of connectors 210A and 210B may allow new service provider systems to be integrated with execution service system 130 without requiring significant modifications to execution service system 130. As such, a new connector with a unified API implementation can be developed for a new service provider system, and execution service system 130 may communicate with this new connector using the same execute operation request 135 format as used with connectors 210A and 210B.

Turning now to FIG. 3A, a block diagram illustrating example connector data stored at configuration store 150 is shown. In the illustrated embodiment, configuration store 150 stores connector data 310 having a set of connector records 320. As further shown, a connector record 320 comprises various fields that include a URL field 331, a variables field 332, a name field 333, a credentials field 335, an eligibility field 336, and a features supported field 337. In various embodiments, configuration store 150 stores a connector record 320 for each connector 210 registered at execution service system 130. The set of connector records 320 may provide a standardized template for defining the properties and characteristics of a given connector 210. Accordingly, the fields may allow for storage and management of information for each connector 210 and enable execution service system 130 to communicate effectively with the corresponding service provider system 120. Connector records 320 may include additional or fewer fields than shown in FIG. 3A.

In various embodiments, URL field 331 stores the endpoint address for a connector 210 to enable execution service system 130 to issue requests (e.g., execute operation requests 135) to that connector 210. Variables field 332 may identify any specific parameters required by the connector 210, enabling the customization and configuration of the connector's operation. For example, variables field 332 may include a variable used to specify the type of operation being requested to be performed by its associated service provider system 120. Name field 333 may store a unique identifier for the connector 210, ensuring each connector 210 can be distinctly recognized and referenced within the system. For example, the name specified for a connector 210 may be based on the name of its associated service provider system 120, which may enable execution service system 130 to access the appropriate connector record 320.

Eligibility field 336 may store information about which entities (e.g., web service providers) are permitted to use the connector 210, which may enable execution service system 130 to enforce access controls and ensure that only authorized entities are able to use the connector's functionalities. Features supported field 337 may store information about the specific functionalities offered by the connector 210, such as transaction types, supported operations, or any special capabilities provided by that connector 210.

In various embodiments, connector records 320 are stored at configuration store 150 as connectors 210 are registered at execution service system 130. As such, when a new service provider system 120 is being integrated with execution service system 130, execution service system 130 may receive a request to register a connector 210 for that service provider system 120 and that request may include a connector record 320. In response to receiving the request to register the connector 210, execution service system 130 may validate the connector record 320 and store it in configuration store 150. After registering that connector 210, then execution service system 130 may interact with the corresponding service provider system 120 through that connector 210. The illustrated fields may therefore be used to dynamically configure new connectors 210, allowing for the seamless integration of additional service provider systems 120. This modular and flexible approach may enhance the scalability and adaptability of the overall system, facilitating efficient management and operation of a diverse set of connectors 210 within configuration store 150.

Turning now to FIG. 3B, a block diagram of an example of a service provider system 120 registering multiple connection configuration records 340 is shown. In illustrated embodiment, there is configuration store 150 and service provider system 120. As further shown, configuration store 150 includes connector data 310 comprising connector configuration records 340A and 340B.

The illustrated service provider system 120 may facilitate an execution flow that involves allocating computer resources to an environment managed by another service provider system 120. The execution flow might include a step in which the illustrated service provider system 120 issues a request to execution service system 130 (via a system of record 110), a step in which execution service system 130 communicates with the other service provider system 120 to allocate the resources, and a step in which the other service provider system 120 allocates the resources. As another example, in the context of transaction processing, the illustrated service provider system 120 may facilitate an execution flow that involves conducting a transaction between a merchant and a customer. The execution flow may include a step in the illustrated service provider system 120 issues a request to execution service system 130 (via a system of record 110) to perform a transaction at another service provider system 120, a step in which execution service system 130 communicates with that other service provider system 120 (via a connector 210) to perform the transaction, and a step in which the other service provider system 120 performs the transaction.

To enable execution service system 130 to interact with that other service provider system 120 on behalf of the illustrated service provider system 120, in various embodiments, the illustrated service provider system 120 provides one or both of connector configuration records 340A and 340B for the connector 210 associated with the other service provider system 120. Connector configuration records 340A and 340B may each specify various information (e.g., authentication credentials) that can be used to interact with the connector 210 and/or the other service provider system 120 on behalf of the illustrated service provider system 120. By way of example, the service provider of the illustrated service provider system 120 may have multiple accounts at the other service provider system 120. As such, the illustrated service provider system 120 may issue a first connection creation request 355 to establish connector configuration record 340A for a first account and a second connection creation request 355 to establish connector configuration record 340B for a second account.

Configuration records 340A and 340B may be associated with the same connector 210, and each connection creation request 355 may include the information needed to enable execution service system 130 to issue requests to the other service provider system 120 for both accounts via the connector 210. For example, configuration records 340A and 340B may include authentication credentials for the first and second accounts, respectively—e.g., a merchant's credentials to be used on the downstream service provider system 120. In some cases, configuration records 340A and 340B are associated with different connectors 210 corresponding to different service provider systems 120. This ability for a service provider to establish multiple connector configuration records 340 with the same service provider system 120 and/or different service provider systems 120 may provide flexibility and scalability—the service provider may establish connector configuration records 340A and 340B for different purposes, such as handling transactions in different currencies or integrating with different service provider systems 120.

Connector data 310 may include additional metadata or configuration options to further customize the behavior of the connectors. Examples may include specifying timeout settings, retry policies, or logging preferences. By maintaining such configuration data, system 100 may ensure that each connector 210 operates optimally and in accordance with the requirements of service provider systems 120. Configuration store 150 may also support versioning of connector configuration records 340 and therefore service provider systems 120 may update or roll back its configurations as needed.

In various embodiments, the illustrated service provider system 120 may interact with a control panel interface that is provided by execution service system 130 to manage connector configurations. The control panel interface may allow the service provider to update or delete existing connector configurations (e.g., connector configuration records 340A and 340B). Also, the control panel interface may allow for the service provider to register new connectors 210 by providing information such as endpoint URLs, credential types, and supported features. The control panel interface may provide a user-friendly dashboard displaying all registered connectors 210, their statuses, and any pending updates or alerts. By leveraging the control panel interface, the service provider can efficiently manage multiple connectors 210 for integration with service provider systems 120.

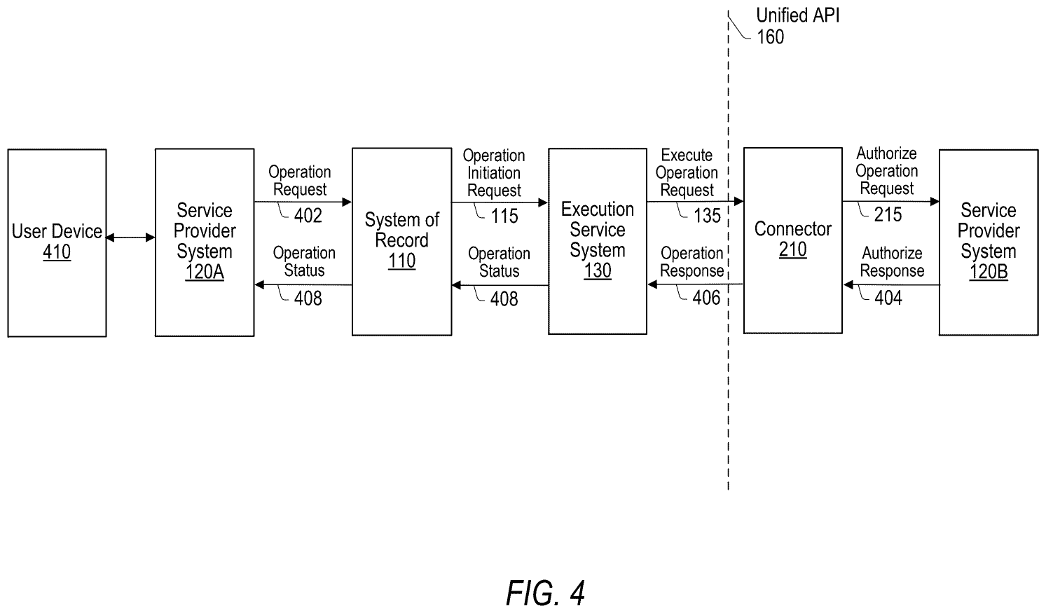

Turning now to FIG. 4, a block diagram of an example of a user device 410 causing a set of operations to be performed at a service provider system 120B is shown. In the illustrated embodiment, there is a system of record 110, service provider systems 120A and 120B, execution service system 130, a connector 210, and user device 410. The illustrated embodiment may be implemented differently than shown. As an example, there may not be system of record 110 between execution service system 130 and service provider system 120A and thus service provider system 120A may directly interact with execution service system 130 (e.g., by issuing operation initiation request 115 and receiving operation status 408). As another example, system of record 110 may be a part of service provider system 120A.

The illustrated communication process may begin with user device 410 communicating with service provider system 120A. User device 410, in various embodiments, can be any of a variety of different computer systems that a user can use to interact with service provider system 120A. Examples of user devices 410 include desktop computers, laptops, mobile phones, TVs, etc. Service provider system 120A may provide any of various types of services. For example, service provider system 120A may provide a website accessible to a user via user device 410. The website of that service may comprise various web pages that can be written in HTML (hypertext markup language) and viewed by the user via a web browser on user device 410. In some embodiments, a provider of service provider system 120A provides an application that can be executed on user device 410—e.g., the user might download a native application onto their smartphone via an application store. In some instances, service provider system 120A may be operated by a merchant and thus service provider system 120A may present various products and services to the user of user device 410. The user may initiate, via user device 410, a transaction to acquire a particular product or service.

In various embodiments, service provider system 120A is a transaction processor that provides a service that allows for users/merchants to perform transactions. Accordingly, while not shown, there may be a merchant system that interacts with service provider system 120A, and user device 410 may interact with the merchant system. Accordingly, a user of user device 410 may initiate a transaction with the merchant system and that transaction may be facilitated by service provider system 120A. To facilitate that transaction, service provider system 120A may interact with service provider system 120B via one or more of the intervening components shown in FIG. 4 (e.g., execution service system 130 and connector 210).

Accordingly, in response to receiving a request to perform a particular operation (e.g., a transaction), service provider system 120A may send operation request 402 to system of record 110. In some embodiments, operation request 402 is formatted as a GraphQL request. Operation request 402 may include information about the requested action or transaction to be performed, such as a payment authorization, user profile update, or data retrieval. Upon receiving operation request 402, system of record 110 may generate operation initiation request 115 and provide it to execution service system 130, where operation initiation request 115 may include information about the requested action or transaction.

Upon receiving operation initiation request 115, execution service system 130 may then identify, based on the information provided in operation initiation request 115, connector 210. For example, operation initiation request 115 may identify a name of the service provider and thus execution service system 130 may use that name to locate connector 210 for that service provider's system. Furthermore, execution service system 130 may determine a configuration (e.g., a connector configuration record 340) to use for connector 210. For example, operation initiation request 115 may identify an account of the service provider and therefore execution service system 130 may select a configuration that identifies authentication credentials for that account. Execution service system 130 may send execute operation request 135 to connector 210 based on the appropriate configuration. Execution service system 130 may act as an intermediary that may translate operation initiation request 115 into a standardized format that conforms to the specifications and protocols defined by unified API 160, which is represented by the dashed vertical line between execution service system 130 and connector 210 in FIG. 4.

In response to receiving execute operation request 135 from execution service system 130, connector 210 may process it and generate authorize operation request 215, which is compatible with service provider system 120B. Authorize operation request 215 may include data and parameters specific to service provider system 120B in a format that is ingestible by service provider system 120B. Upon receiving authorize operation request 215, service provider system 120B may then perform the requested operation(s) and generate authorize response 404. Authorize response 404 may include information about the status and outcome of the performed operations, such as whether the operation of a particular type (e.g., a transaction) was approved or declined. Connector 210 may receive authorize response 404 and generate operation response 406 that may be sent back to execution service system 130. This response may ensure that execution service system 130 is aware of the outcome and can take any appropriate actions based on the status. In some embodiments, authorize response 404 is routed to connector 210, which returns operation response 406 to execution service system 130.

In response to receiving operation response 406, execution service system 130 may update system of record 110 with operation status 408. In some embodiments, operation status 408 may reflect the current state of the operation, ensuring that system of record 110 maintains accurate and up-to-date information. In some instances, the response from execution service system 130 to system of record 110 (e.g., operation status 408) may be formatted as a GraphQL response. In particular, operation initiation request 115 may be a GraphQL request in which system of record 110 identifies what pieces of data to return in a response—operation initiation request 115 may include a query for certain data. As such, the response form execution service system 130 to system of record 110 may be a GraphQL response that includes all of the relevant data. Using this GraphQL approach may allow different entities to obtain data that is relevant to them—that is, instead of one-size-fits-all response, different entities can meet their own specific data needs by being able to control the data returned by execution service system 130. After receiving operation status 408, system of record 110 may then provide operation status 408 to service provider system 120A, which in turn may update user device 410 with the relevant information. This step may ensure that the user is informed about the outcome of their request, providing transparency and confirmation of the completed action.

As discussed, the use of unified API 160 may allow for execution service system 130 to communicate with multiple connectors 210, each associated with a different service provider system 120, using a standardized format and protocol. This can simplify the integration process and reduce the need for custom implementations for each service provider system 120. By simplifying the integration with different service provider systems 120, unified API 160 and connectors 210 may provide a flexible and scalable solution for managing interactions across different platforms. For example, a new service provider systems 120 may be added by creating a new connectors 210 that adhere to the specifications of unified API 160, without requiring significant modifications to the other components of FIG. 4. This approach may allow for service provider system 120A to benefit from the functionality of multiple service provider systems 120—for example, by being able to conduct transactions across different transaction processors.

In various embodiments, the illustrated components implement robust error handling mechanisms to ensure reliability and stability. By way of example, if operation request 402 fails during any stage of processing, system of record 110 may generate an error notification and send it to execution service system 130. Execution service system 130 may log the error details and initiate predefined retry policies stored in configuration store 150. For example, if a transaction request fails due to a network issue, execution service system 130 may retry the request a specified number of times before marking the operation as failed and notifying service provider system 120A. This error handling may help maintain the integrity and continuity of operations in system 100. As another example, if system 100 fails to process an asynchronous notification payload (which will be discussed in greater detail in FIG. 5 below) due to an error, it can receive a status request from system of record 110, send a status request to connector 210, and receive information identifying operation status 408 that it can provide to system of record 110.

Turning now to FIG. 5, a block diagram illustrating an example of an asynchronous notification process is shown. In the illustrated embodiment, there is a system of record 110, execution service system 130, service provider systems 120A and 120B, configuration store 150, a connector 210, a notifications service 510, and a notifications queue 520. In various aspects, the process as shown in FIG. 5 is similar to the process discussed above with respect to FIG. 4, where user device 410 triggers, via service provider system 120A, system of record 110, execution service system 130, and connector 210, service provider system 120B to perform an operation of a particular type.

In some cases, requested operations may not be completed immediately and thus may involve asynchronous notifications to update the status. In the context of transaction processing for example, a transaction may initially be pre-approved by service provider system 120B, which may provide, to connector 210, authorize response 404 to indicate the pre-approval. Service provider system 120B may subsequently approve the transaction and provide asynchronous notification 502 about the approval to notify notifications service 510 about an update to the operation status of an operation. Asynchronous notification 502 may include the update to the operation status (e.g., for a transaction this may be approved, declined, pending; for a user data update this may be successful, failed, etc.). Notifications service 510, in various embodiments, is a service that handles incoming asynchronous notifications 502 and manages the distribution of notifications 502 to the relevant components. Notifications service 510 may therefore ensure that updates are processed efficiently and the relevant components (e.g., system of record 110) are informed about changes in operation status.

In some cases, asynchronous notification 502 is in a format that cannot be ingested by notifications service 510 and execution service system 130. But asynchronous notification 502 may be ingestible by connector 210. Accordingly, upon receiving asynchronous notification 502, notifications service 510 may access the relevant configuration data from configuration store 150 for connector 210. Configuration store 150 may also store other data for processing such notifications 502, including details about how to verify and validate particular notifications. After obtaining the relevant configuration data, notifications service 510 may send notification response 504 to connector 210 based on the configuration data (e.g., the URL of connector 210). If asynchronous notification 502 includes the update to the operation status, connector 210 may extract the update from asynchronous notification 502 and respond with operation status response 512 to notifications service 510. If asynchronous notification 502 does not include enough information to construct response 512, then connector 210 may send operation status request 506 to service provider system 120B to fetch the latest operation status. Service provider system 120B may respond with operation status 408, which connector 210 may respond with as operation status response 512 to notifications service 510. But in some embodiments, asynchronous notification 502 can be ingested by notifications service 510 and thus notifications service 510 may determine the update to the operation status without having to communicate with connector 210.

After receiving operation status response 512, notifications service 510 may enqueue the status information from operation status response 512 into notifications queue 520. In various embodiments, notifications queue 520 stores the status information until it can be processed by the appropriate component (e.g., system of record 110). System of record 110 may interact with notifications queue 520 to retrieve the updated operation status so that system of record 110 can update the status of a record pertaining to the requested operation. This may ensure that system of record 110 maintains accurate and up-to-date records for the operations requested by its users. In some embodiments, instead of enqueueing the status information so that system of record 110 can pull the information from notifications queue 520, notifications service 510 sends/pushes the status information to system of record 110.

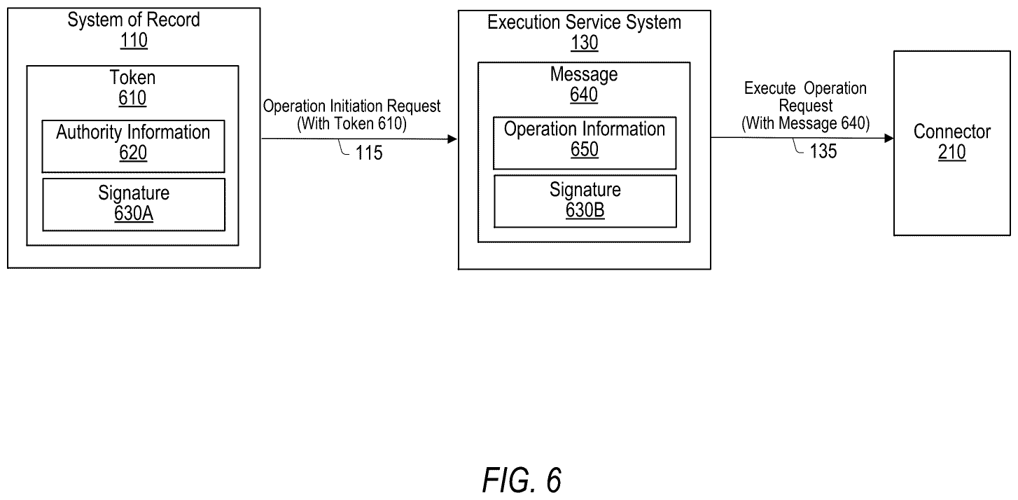

Turning now to FIG. 6, a block diagram illustrating elements of an authorization process that pertains to an interaction between a system of record 110, execution service system 130, and a connector 210 is shown. In the illustrated embodiment, system of record 110 includes a token 610 and execution service system 130 generates a message 640. As shown, token 610 includes authority information 620 and signature 630A, and message 640 includes operation information 650 and signature 630B.

In various embodiments, system of record 110 generates an operation initiation request 115 to include token 610, which may enable secure and authenticated operations. For example, token 610 can include authority information 620 that may indicate the rights and privileges required for a requested operation and ensure that initiation request 115 originates from an authorized source. That is, authority information 620 that may specify as a set of credentials proving the request's validity and the rights associated with it. Token 610 can include signature 630A, which may be a cryptographic signature that guarantees the integrity and authenticity of token 610. In various embodiments, system of record 110 generates token 610 based on data pertaining to the requestor (e.g., a web service provider) whose is requesting that an operation be performed at a particular service provider system 120. For example, system of record 110 may determine that a web service provider has the authority to request a particular operation and include an indication of this authority in token 610.

In some embodiments, token 610 may be a JSON Web Token (JWT) that is a compact, URL-safe means of representing claims to be transferred between two parties—e.g., JWTs may be used in web applications to authenticate users and authorize actions. Accordingly, token 610, including its authority information 620 and signature 630A, may be formatted as a JWT, ensuring that execution service system 130 can validate token 610 and extract the relevant information for authorization. Token 610 is not limited to being a JWT. Token 610 may be, for example, a Platform-Agnostic Security token, an Open Authorization token, or a Fernet token.

Upon generating token 610, system of record 110 may attach it to operation initiation request 115 and send initiation request 115 to execution service system 130. Execution service system 130 may then validate token 610. In various embodiments, this validation can involve checking authority information 620 to confirm that the requestor has the relevant rights and verifying signature 630A to ensure that token 610 has not been tampered with. Once token 610 is validated, execution service system 130 may generate a message 640. Message 640 may include operation information 650 that specifies the specifics of the operation to be executed, such as the actions to be performed and the data (e.g., authentication credentials) involved. To maintain the security and integrity of message 640 during transmission, execution service system 130 may sign it with signature 630B that ensures that any modifications to message 640 during transmission would be detectable. Execution service system 130 may then send an execute operation request 135, including message 640, to connector 210. Connector 210 may interface with the appropriate service provider system to execute the operation as specified in message 640. By using the signed message 640, connector 210 can trust that the request is legitimate and has not been altered.

The use of tokens and cryptographic signatures at multiple stages may ensure secure and authenticated communication between components. As such, token 610, with its authority information 620 and signature 630A, may ensure that operation initiation request 115 is valid and authorized by system of record 110. Similarly, message 640, with its operation information 650 and signature 630B, may allow connector 210 to determine that execute operation request 135 is authentic and has not been tampered with during transmission from execution service system 130 to connector 210.

In some embodiments, execution service system 130 receives an authenticated request from system of record 110, generate an authorized API request based on the authenticated request, and send this authorized API request to connector 210. This process may ensure that the operations requested are authenticated and authorized before being processed by connector 210. The authenticated request may include a token, such as a JWT, an Open Authentication token, a Fernet token, etc., which details a set of rights and privileges for the request. This token may provide a secure way to convey authorization information and may ensure that the requestor has the relevant permissions to perform the operation. In some embodiments, execution service system 130 verifies that the token is valid and signed by a trusted key. This step may ensure that the token has not been tampered with and that it originates from a trusted source. Additionally, execution service system 130 may validate that the holder of the token has the rights to perform the operation, adding another layer of security. In some embodiments, the authorized API request can be signed using an Internet Engineering Task Force (IETF) HTTP message signature specification. This specification may provide a standardized way to sign HTTP messages, ensuring their integrity and authenticity during transmission. The API request may be signed under other approaches, such as JSON web signatures or Amazon Web Services® Signature Version 4.

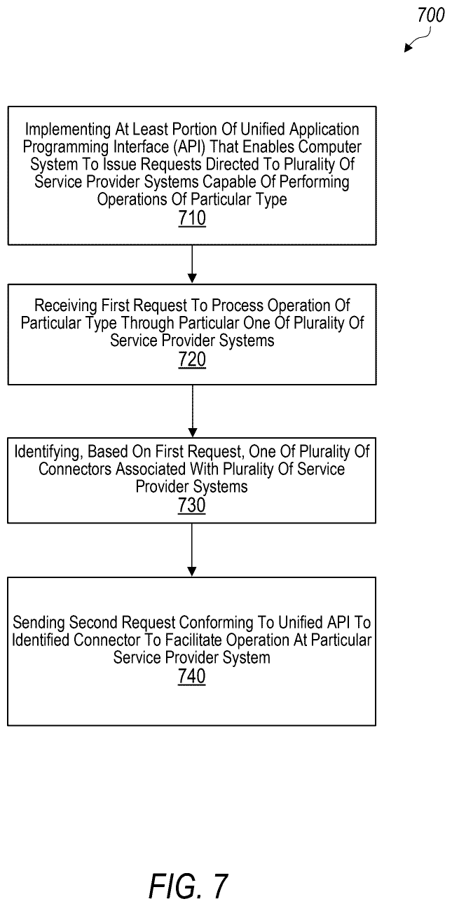

Turning now to FIG. 7, a flow diagram of a method 700 is shown. Method 700 is one embodiment of a method performed by a computer system (e.g., system 100) to facilitate an operation at a service provider system (e.g., a service provider system 120) through a unified API (e.g., unified API 160). Method 700 may be performed by executing program instructions stored on a non-transitory computer-readable medium. Method 700 may be used in conjunction with any of the computer circuitry, systems, devices, elements, and/or components disclosed herein, among others. In various embodiments, some of the method elements shown may be performed concurrently, in a different order than shown, or may be omitted. Additional method elements may also be performed—e.g., method 700 may include a step in which the computer system provides a response to an issuer of the request to perform the operation at the service provider system.

Method 700 begins in step 710 with the computer system implementing at least a portion of the unified API that enables the computer system to issue requests directed to a plurality of service provider systems capable of performing operations of a particular type. In various embodiments, the requests have a common format, and the operations of the particular type may include, but are not limited to, data retrieval, transactions (e.g., database transactions, financial transactions, etc.), user profile updates, etc. In step 720, the computer system receives a first request (e.g., an operation initiation request 115) to process an operation of the particular type through a particular one of the plurality of service provider systems. The first request may be generated by a system of record (e.g., a system of record 110) and sent to the computer system. In some embodiments, that request is formatted as a GraphQL request and a response (e.g., an operation status 408) from the computer system is formatted as a GraphQL response.

In step 730, the computer system identifies, based on the first request, one of a plurality of connectors (e.g., connectors 210) associated with the plurality of service provider systems. In various embodiments, a given connector is operable to handle requests according to a set of specifications of the unified API and interface with a respective one of the plurality of service provider systems. In some embodiments, the set of specifications defined by the unified API includes at least one security protocol to ensure secure communications between the computer system and the plurality of service provider systems. For example, the unified API may include specifications that may define how requests and responses are formatted and processed—e.g., security protocols may include cryptographic signatures (e.g., signature 630A, 630B), token validation (e.g., token 610), and/or secure transmission protocols (e.g., IETF HTTP message signature).

In various embodiments, the computer system registers the connector according to the set of specifications defined by the unified API. The registration may include storing a set of connector data associated with the connector in a configuration store (e.g., configuration store 150). Examples of fields registered for the connector may include URL field 331, variables field 332, name field 333, credentials field 335, eligibility field 336, and/or features supported field 337. The computer system may receive a request (e.g., a connection creation request 355) from a service provider (e.g., a service provider of a service provider system 120 that implements a website) to create a connection/configuration with the registered connector. The request may specify authentication credentials associated with the service provider for performing/initiating the particular operation at the particular service provider system on behalf of the service provider. In response to receiving a request to register the connector, the computer system may register the connector, including storing connector data that specifies one or more properties for the connector that include a network address (e.g., a URL). The service provider may establish multiple connections with the same connector. Thus, the computer system may store connector data having multiple connector configuration records for the service provider. The multiple connector configuration record may permit the service provider to perform operations of the particular type with respect to different accounts at the particular service provider system.

In step 740, the computer system sends a second request (e.g., an execute operation request 135) conforming to the unified API to the identified connector to facilitate the operation at the particular service provider system, including conforming content of the second request to a format ingestible by the particular service provider system. In various cases, the computer system receives a notification payload from the particular service provider system that is in a format ingestible by the identified connector. The asynchronous notification payload may be indicative of an update to an operation status (e.g., for a payment transaction this may be approved, declined, pending; for a user data update this may be successful, failed, etc.) of the operation at the particular service provider system. In some embodiments, the computer system sends the notification payload to the connector for processing and receives the updated operation status from the connector based on the processed notification response. For example, execution service system 130 may receive the updated operation status (e.g., operation response 406) from connector 210 based on processed notification response 504. In some embodiments, the computer system causes an operation record in the system of record to be updated based on the updated operation status.

In some embodiments, the computer system enqueues the updated operation status into a notifications queue (e.g., a notifications queue 520) that is accessible to the system of record. The system of record may retrieve the updated operation status from the notification queue and update a record corresponding to the particular operation to have the updated operation status. In some embodiments, the computer system receives an asynchronous notification payload from the service provider system and fails to process the asynchronous notification payload due to an error. As such, the computer system may receive from the system of record a request for the operation status pertaining to the particular operation. The computer system may send a status request to the connector requesting the operation status pertaining to the particular operation, receive information identifying the operation status, and provide the information to the system of record. The system of record may retrieve the updated operation status via direct queue interaction.

In some embodiments, the computer system receives an update request from the service provider to update the set of connector data for the registered connector, updates the set of connector data for the registered connector in the configuration store, and notifies the service provider of the updated set of connector data. In some embodiments, the computer system provides a control panel interface for the service provider and enables the service provider to configure the connection with the registered connector via the control panel interface.

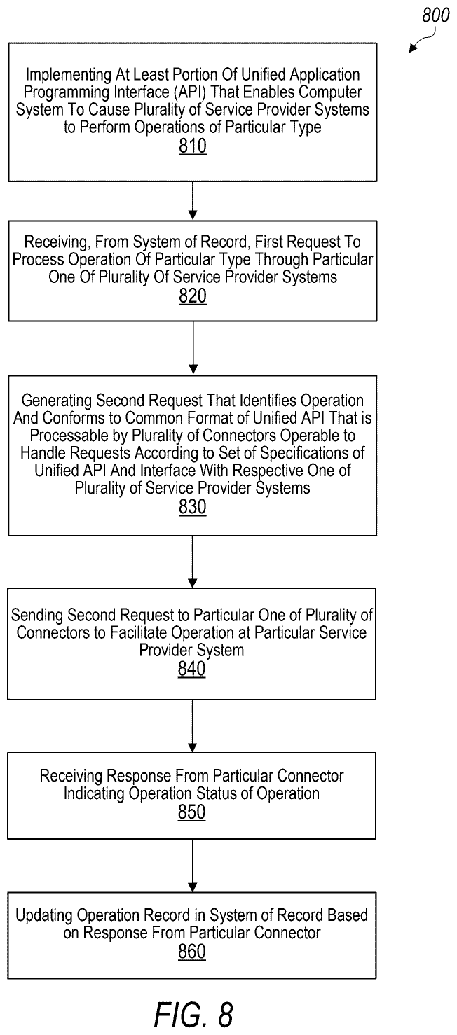

Turning now to FIG. 8, a flow diagram of a method 800 is shown. Method 800 is one embodiment of a method performed by a computer system (e.g., system 100) to facilitate an operation at a service provider system (e.g., a service provider system 120) through a unified API (e.g., unified API 160). Method 800 may be performed by executing program instructions stored on a non-transitory computer-readable medium. Method 800 may be used in conjunction with any of the computer circuitry, systems, devices, elements, and/or components disclosed herein, among others. In various embodiments, some of the method elements shown may be performed concurrently, in a different order than shown, or may be omitted. Additional method elements may also be performed.

Method 800 begins in step 810 with the computer system implementing at least a portion of the unified API that enables the computer system to cause a plurality of service provider systems to perform operations of a particular type. In step 820, the computer system receives, from a system of record (e.g., a system of record 110), a first request (e.g., an operation initiation request 115) to process an operation of the particular type through a particular one of the plurality of service provider systems. In various embodiments, the first request includes a JSON Web Token (JWT) that specifies a set of permissions associated with requesting ones of the plurality of service provider systems to perform operations. As such, the computer system may verify that the JWT is valid and signed by a trusted key and validate that a holder of the JWT has permission to request performance of the operation at the particular service provider system.

Prior to the receiving of the first request to process the operation of the particular type, the computer system may register the particular connector, including storing connector data (e.g., connector data 310) that specifies one or more properties for the particular connector that include a network address of the connector and one or more settings that are configurable by a service provider (e.g., via a service provider system 120) when establishing a configuration that associates the given service provider with the particular connector. The computer system may store configuration data (e.g., a connector configuration record 340) in association with the connector and a service provider associated with the first request. The configuration data includes a set of authentication credentials that permits the computer system to send the second request on behalf of the service provider. In some embodiments, the computer system provides a control panel interface that enables the service provider to create and modify a configuration included in the configuration data. In some cases, the configuration data may be associated with multiple configurations established by the service provider that pertain to the particular connector. The multiple configurations may permit the service provider to perform operations of the particular type with respect to different accounts of the service provider at the particular service provider system.

In step 830, the computer system generates a second request (e.g., an execute operation request 135) that identifies the operation and conforms to a common format of the unified API that is processable by a plurality of connectors operable to handle requests according to a set of specifications of the unified API and interface with a respective one of the plurality of service provider systems. In step 840, the computer system sends the second request to a particular one of the plurality of connectors to facilitate the operation at the particular service provider system, including conforming content of the second request to a format ingestible by the particular service provider system.

In step 850, the computer system receives a response from the particular connector indicating an operation status of the operation. In step 860, the computer system updates an operation record in the system of record based on the response from the particular connector. In particular, the computer system may receive a notification payload (e.g., an asynchronous notification 502) from the particular service provider system that is in a format ingestible by the particular connector. After sending the notification payload to the particular connector, the computer system may receive a response (e.g., an operation status response 512) identifying an operation status of the operation at the particular service provider system. The updating of the operation record may include enqueuing information identifying the operation status into a notifications queue (e.g., notifications queue 520) that is accessible to the system of record to retrieve the information from the notifications queue and update the operation record.

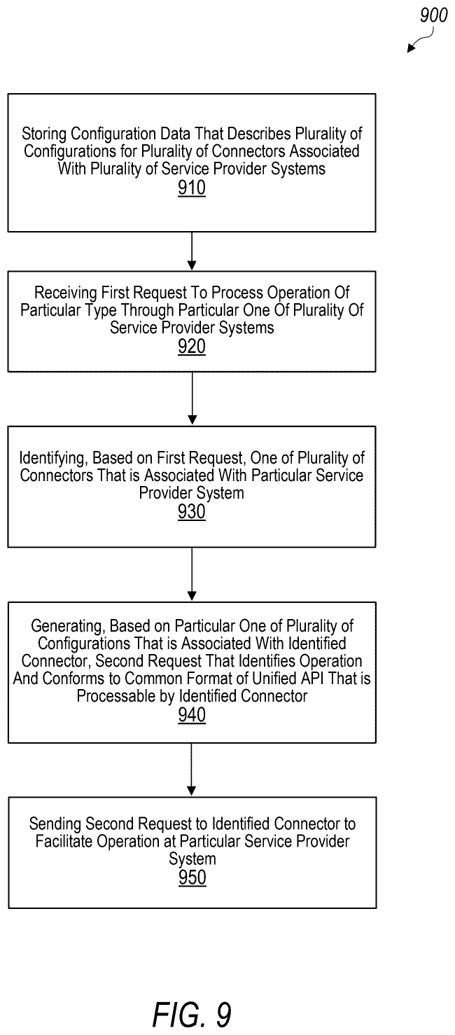

Turning now to FIG. 9, a flow diagram of a method 900 is shown. Method 900 is one embodiment of a method performed by a computer system (e.g., system 100) to facilitate an operation at a service provider system (e.g., a service provider system 120) through a unified API (e.g., unified API 160). Method 900 may be performed by executing program instructions stored on a non-transitory computer-readable medium. Method 900 may be used in conjunction with any of the computer circuitry, systems, devices, elements, and/or components disclosed herein, among others. In various embodiments, some of the method elements shown may be performed concurrently, in a different order than shown, or may be omitted. Additional method elements may also be performed.

Method 900 begins in step 910 with the computer system storing configuration data (e.g., connector data 310) describing a plurality of configurations for a plurality of connectors (e.g., connectors 210) associated with a plurality of service provider systems. A connector may be operable to handle requests according to the unified API and interface with a respective one of the plurality of service provider systems. In step 920, the computer system receives a first request to process an operation of a particular type through a particular one of the plurality of service provider systems.

In step 930, the computer system identifies, based on the first request, one of a plurality of connectors that is associated with the particular service provider system. In step 940, the computer system generates, based on a particular one of the plurality of configurations that is associated with the identified connector, a second request that identifies the operation and conforms to a common format of the unified API that is processable by the identified connector. In step 950, the computer system sends the second request to the identified connector to facilitate the operation at the particular service provider system, including conforming content of the second request to a format ingestible by the particular service provider system.

In some embodiments, the computer system receives a notification payload from the particular service provider system that is in a format ingestible by the particular connector but not by the system. The computer system may send the notification payload to the identified connector for processing and receive, from the identified connector, a response identifying an operation status of the operation at the particular service provider system. The computer system may then enqueue information identifying the operation status into a notifications queue (e.g., notifications queue 520) accessible to a system of record (e.g., a system of record 110) that issued the first request.

### Exemplary Computer System

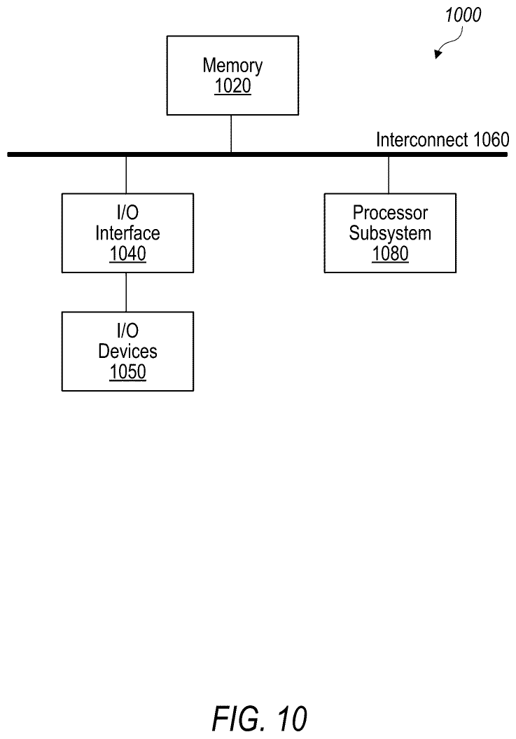

Turning now to FIG. 10, a block diagram of an exemplary computer system 1000, which may implement system 100, a system of record 110, execution service system 130, a service provider system 120, and/or user device 410, is shown. Computer system 1000 includes a processor subsystem 1080 that is coupled to a system memory 1020 and I/O interfaces(s) 1040 via an interconnect 1060 (e.g., a system bus). I/O interface(s) 1040 is coupled to one or more I/O devices 1050. Although a single computer system 1000 is shown in FIG. 10 for convenience, system 1000 may also be implemented as two or more computer systems operating together.

Processor subsystem 1080 may include one or more processors or processing units. In various embodiments of computer system 1000, multiple instances of processor subsystem 1080 may be coupled to interconnect 1060. In various embodiments, processor subsystem 1080 (or each processor unit within 1080) may contain a cache or other form of on-board memory.

System memory 1020 is usable store program instructions executable by processor subsystem 1080 to cause system 1000 perform various operations described herein. System memory 1020 may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 1000 is not limited to primary storage such as memory 1020. Rather, computer system 1000 may also include other forms of storage such as cache memory in processor subsystem 1080 and secondary storage on I/O Devices 1050 (e.g., a hard drive, storage array, etc.). In some embodiments, these other forms of storage may also store program instructions executable by processor subsystem 1080. In some embodiments, program instructions that when executed implement execution engine 140, configuration store 150, a connector 210, notifications service 510, and/or notifications queue 520 may be included/stored within system memory 1020.

I/O interfaces 1040 may be any of various types of interfaces configured to couple to and communicate with other devices, according to various embodiments. In one embodiment, I/O interface 1040 is a bridge chip (e.g., Southbridge) from a front-side to one or more back-side buses. I/O interfaces 1040 may be coupled to one or more I/O devices 1050 via one or more corresponding buses or other interfaces. Examples of I/O devices 1050 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 1000 is coupled to a network via a network interface device 1050 (e.g., configured to communicate over WiFi, Bluetooth, Ethernet, etc.).

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S. C. § 112(f) for that claim element. Should Applicant wish to invoke Section 112(f) during prosecution of a United States patent application based on this disclosure, it will recite claim elements using the “means for” [performing a function] construct.

What is claimed is:

1. A method, comprising:
implementing, by a computer system, at least a portion of a unified application programming interface (API) that enables the computer system to issue requests directed to a plurality of service provider systems capable of performing operations of a particular type, wherein the requests have a common format;
receiving, by the computer system, a first request to process an operation of the particular type through a particular one of the plurality of service provider systems;
identifying, by the computer system based on the first request, one of a plurality of connectors associated with the plurality of service provider systems, wherein a given connector is operable to handle requests according to a set of specifications of the unified API and interface with a respective one of the plurality of service provider systems; and
sending, by the computer system, a second request conforming to the unified API to the identified connector to facilitate the operation at the particular service provider system, including conforming content of the second request to a format ingestible by the particular service provider system.

2. The method of claim 1, further comprising:
receiving, by the computer system, a notification payload from the particular service provider system that is in a format ingestible by the identified connector;
sending, by the computer system, the notification payload to the identified connector for processing; and
receiving, by the computer system from the identified connector, a response identifying an operation status of the operation at the particular service provider system.

3. The method of claim 2, further comprising:
enqueuing, by the computer system, information identifying the operation status into a notification queue that is accessible to a system of record that is operable to retrieve the information from the notification queue and update a record corresponding to the operation to have the operation status.

4. The method of claim 1, further comprising:
maintaining, by the computer system, a connector store storing connector data associated with the plurality of connectors, wherein the connector data specifies, for a given one of the plurality of connectors, a set of properties associated with the given connector; and
in response to receiving a request to register an additional connector, the computer system registering the additional connector, including storing additional connector data in the connector store that specifies one or more properties for the additional connector that include a network address of the additional connector.

5. The method of claim 4, wherein the additional connector data specifies:
eligibility criteria indicative of which ones of a plurality of service providers are permitted to utilize the additional connector; and
one or more settings that are configurable by a service provider when establishing a configuration that associates the service provider with the additional connector.

6. The method of claim 1, further comprising:
receiving, by the computer system, a request to generate a first configuration with the identified connector, wherein the request specifies a set of authentication credentials for initiating the operation at the particular service provider system on behalf of a service provider; and
storing, by the computer system, configuration data in association with the identified connector and the service provider, wherein the configuration data includes the set of authentication credentials, and wherein the second request to the identified connector includes the set of authentication credentials.

7. The method of claim 6, wherein the service provider is associated with a second configuration with the identified connector, wherein the first and second configurations permit the computer system to initiate operations at the particular service provider system with respect to different accounts associated with the service provider.

8. The method of claim 6, further comprising:
storing, by the computer system, additional configuration data in association with the identified connector and a different service provider, wherein the additional configuration data establishes a second configuration with the identified connector and includes a different set of authentication credentials for initiating the operation at the particular service provider system on behalf of the different service provider.

9. The method of claim 1, wherein the set of specifications defined by the unified API identifies at least one security protocol for establishing secure communications between the computer system and the plurality of service provider systems via the plurality of connectors.

10. A non-transitory computer-readable medium having program instructions stored thereon that are capable of causing a computer system to perform operations comprising:
implementing at least a portion of a unified application programming interface (API) that enables the computer system to cause a plurality of service provider systems to perform operations of a particular type;
receiving, from a system of record, a first request to process an operation of the particular type through a particular one of the plurality of service provider systems;
generating a second request that identifies the operation and conforms to a common format of the unified API that is processable by a plurality of connectors operable to handle requests according to a set of specifications of the unified API and interface with a respective one of the plurality of service provider systems; and
sending the second request to a particular one of the plurality of connectors to facilitate the operation at the particular service provider system, including conforming content of the second request to a format ingestible by the particular service provider system;
receiving a response from the particular connector indicating an operation status of the operation; and
updating an operation record in the system of record based on the response from the particular connector.

11. The non-transitory computer-readable medium of claim 10, wherein the operations further comprise:
receiving a notification payload from the particular service provider system that is in a format ingestible by the particular connector; and
subsequent to sending the notification payload to the particular connector, receiving a response identifying an operation status of the operation at the particular service provider system, wherein the updating of the operation record includes enqueuing information identifying the operation status into a notification queue that is accessible to the system of record to retrieve the information from the notification queue and update the operation record.

12. The non-transitory computer-readable medium of claim 10, wherein the operations further comprise:
prior to the receiving of the first request to process the operation of the particular type:
registering the particular connector, including storing connector data that specifies one or more properties for the particular connector that include a network address of the particular connector and one or more settings that are configurable by a given service provider when establishing a configuration that associates the given service provider with the particular connector; and
storing configuration data in association with the particular connector and a service provider associated with the first request, wherein the configuration data includes a set of authentication credentials that permits the computer system to send the second request on behalf of the service provider.

13. The non-transitory computer-readable medium of claim 12, wherein the configuration data is associated with a configuration pertaining to the particular connector, and wherein the operations further comprise providing a control panel interface that enables the service provider to create and modify the configuration.

14. The non-transitory computer-readable medium of claim 12, wherein the configuration data is associated with multiple configurations established by the service provider that pertain to the particular connector, and wherein the multiple configurations permit the service provider to perform operations of the particular type with respect to different accounts of the service provider at the particular service provider system.

15. The non-transitory computer-readable medium of claim 11, wherein the first request includes a JSON Web Token (JWT) that specifies a set of permissions associated with requesting ones of the plurality of service provider systems to perform operations, and wherein the operations further comprise:
verifying that the JWT is valid and signed by a trusted key; and
validating that a holder of the JWT has permission to request performance of the operation at the particular service provider system.

16. A system, comprising:
at least one processor; and
memory having program instructions stored thereon that are executable by the at least one processor to cause the system to perform operations comprising:
storing configuration data that describes a plurality of configurations for a plurality of connectors associated with a plurality of service provider systems, wherein a given connector is operable to handle requests according to a unified application programming interface (API) and interface with a respective one of the plurality of service provider systems; and
receiving a first request to process an operation of a particular type through a particular one of the plurality of service provider systems;
identifying, based on the first request, one of a plurality of connectors that is associated with the particular service provider system;
generating, based on a particular one of the plurality of configurations that is associated with the identified connector, a second request that identifies the operation and conforms to a common format of the unified API that is processable by the identified connector; and
sending the second request to the identified connector to facilitate the operation at the particular service provider system, including conforming content of the second request to a format ingestible by the particular service provider system.

17. The system of claim 16, wherein the operations further comprise:
receiving a notification payload from the particular service provider system that is in a format ingestible by the particular connector but not by the system; and
sending the notification payload to the identified connector for processing; and
receiving, from the identified connector, a response identifying an operation status of the operation at the particular service provider system; and
enqueuing information identifying the operation status into a notification queue accessible to a system of record that issued the first request.

18. The system of claim 16, wherein the operations further comprise:
registering the identified connector, including storing connector data specifying a network address of the identified connector and one or more settings that are configurable by a given service provider when establishing a given configuration, wherein the particular configuration is associated with a service provider corresponding to the first request and includes a set of authentication credentials that permits the system to send the second request on behalf of the service provider.

19. The system of claim 18, wherein the service provider is associated with another configuration with the identified connector, wherein the particular configuration and the other configuration permit the system to initiate operations at the particular service provider system with respect to different accounts associated with the service provider.

20. The system of claim 16, wherein the first request specifies a set of permissions associated with requesting ones of the plurality of service provider systems to perform operations, and wherein the operations further comprise validating, based on the set of permissions, whether a service provider corresponding to the first request has permission to request performance of the operation.
